(19) United States
(12) Patent Application Publication
(10) Pub. No.: US 2016/0148132 A1
(43) Pub. Date: May 26, 2016

(54) ERGONOMIC RISK ASSESSMENT

(71) Applicant: INTERNATIONAL BUSINESS MACHINES CORPORATION, Armonk, NY (US)

(72) Inventors: Faisal Aqlan, Poughkeepsie, NY (US); Warren Boldrin, Montgomery, NY (US); Sreekanth Ramakrishnan, Salem, MA (US); Michael V. Testani, SR., Vestal, NY (US)

(73) Assignee: INTERNATIONAL BUSINESS MACHINES CORPORATION, Armonk, NY (US)

(21) Appl. No.: 14/549,640

(22) Filed: Nov. 21, 2014

(51) Int. Cl. G06Q 10/06

(52) U.S. Cl. CPC G06Q 10/0635; G06Q 10/063116

(57) ABSTRACT

Embodiments of the invention relate to an attribute based approach for assessment ergonomic risks, and applying the assessment to reduce the identified ergonomic risks. Ergonomic risks scores are calculated for risk type, operator, and workplace areas. Risks levels are minimized through mitigation strategies and effectiveness and ease of implementation. An operator is assigned or re-allocated to a designated workplace area based on consideration of both workload and ergonomic risk.

### BACKGROUND

The present invention relates to ergonomic risk assessment. More specifically, the invention relates to integrating ergonomic risk calculations with operator assignment and assessment.

Ergonomics is the scientific discipline concerned with the understanding of interactions among humans, and other elements of a system. Theories, principles, data, and design methods are applied in order to optimize human factors and overall system performance. More specifically, ergonomics is a systems-oriented discipline which extends across all aspects of human activity. With respect to a work place environment, ergonomics has a direct impact on productivity, performance, and throughput.

Ergonomics covers all aspects of a job, from the physical stresses it places on joints, muscles, nerves, tendons, bones and the like, to environmental factors which can affect hearing, vision, and general comfort and health. Physical stressors include repetitive motions such as those caused by typing or continual use of a manual screwdriver. Other physical stressors could be tasks involving vibration such as using a jackhammer, or tasks which involve using excessive force, such as lifting boxes of heavy books. Working in an awkward position, such as holding a telephone to your ear with your shoulder, can also cause problems. Repetitive motions, vibration, excessive force, and awkward positions are frequently linked to ergonomic disorders; however, the majority of “Cumulative Trauma Disorders” (CTDs) or “Repetitive Strain Injuries” (RSIs) are caused by repetitive motions that would not result in undue stress or harm if only performed once. Carpal tunnel syndrome, Tendonitis, Tenosynovitis, DeQuarvain's Syndrome, Thoracic Outlet Syndrome, many back injuries, and several other conditions may result from repetitive motions.

Environmental factors could include such things as indoor air quality or excessive noise. “Sick building syndrome”, with its accompanying headaches, congestion, fatigue and even rashes, can result from poor air quality in a building or office. Excessive noise around heavy machinery or equipment can cause permanent hearing loss. Improper lighting can cause eyestrain and headaches, especially in conjunction with a computer monitor. Accordingly, with respect to a work place environment, ergonomics has a direct impact on productivity, performance, and throughput.

### SUMMARY

The invention includes a method, computer program product, and system for minimizing ergonomic risk based on one or more mitigation strategies and implementation thereof.

A method, computer program product, and system are provided for ergonomic risk and assessment and planning operational tasks of a workplace. Workplace assessment data is received and stored. The workplace is separated into areas, and for each of these area, ergonomic risks are evaluated based on physical characteristics and the planned tasks. The evaluation includes generating an initial ergonomic risk score. In addition, each operator that is a part of the evaluation is assessed for both a risk area factor and a risk type factor. Based on the evaluations, a cumulative ergonomic score is calculated. More specifically, the cumulative score calculation is aggregated across each operator, workplace area, and task. A balance to the workload is implemented, with the basis of the balancing based on identification of workload resources that are available for modification to meet a balance goal. More specifically, formatted data is created and applied to an associated workload schedule, with the application allocating resources to mitigate ergonomic risk

Other features and advantages of this invention will become apparent from the following detailed description of the presently preferred embodiment(s) of the invention, taken in conjunction with the accompanying drawings.

### BRIEF DESCRIPTION OF THE SEVERAL VIEWS OF THE DRAWINGS

The drawings reference herein form a part of the specification. Features shown in the drawings are meant as illustrative of only some embodiments of the invention, and not of all embodiments of the invention unless otherwise explicitly indicated.

FIG. 1 depicts a flow chart illustrating a process for ergonomic risk assessment.

FIG. 2 depicts a flow chart illustrating a process for building a body risk map.

FIG. 3 depicts a block diagram of a risk operator matrix.

FIG. 4 depicts a flow chart illustrating a process for assessing a workplace partition.

FIG. 5 depicts a flow chart illustrating a process for risk aggregation, including ergonomic risk evaluation on a task basis.

FIG. 6 depicts a block diagram illustrating a workplace, and specifically workplace areas.

FIG. 7 depicts a block diagram illustrating an example of a body risk map.

FIG. 8 depicts a block diagram illustrating an interface for the tool.

FIG. 9 depicts a block diagram illustrating an interface for implementing risk mitigation.

FIG. 10 depicts a block diagram illustrating a system for ergonomic risk assessment.

FIG. 11 depicts a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

It is understood that in a productive work place environment operators are assigned to perform on or more tasks. One operator may be trained to perform different types of tasks, thereby making their presence in the workplace valuable due to flexibility with task assignment. At the same time, different tasks may have different risks associated therewith. These risks may be operator dependent, or in one embodiment, independent of an operator. Similarly, an individual risk may be low, but when aggregated with other related or non-related tasks and associated risks, the aggregated risk may be high. Human comfort level is integrated with ergonomic risk factors, such as physical characteristics, task complexity, and environmental conditions. An integrated ergonomic risk, also referred to as the ergonomic body risk map score, is used to effectively plan workload and capacity, along with employees skills and workmanship. Ergonomic risk calculations by area and operator are used to allocate or reallocate an appropriate operator to a task or resource so that the aggregated risk cannot exceed an allowable ergonomic risk limit. Accordingly, effective employment of the ergonomic risk calculations ensures that operators are not susceptible to injuries and stress level, while meeting workload requirements.

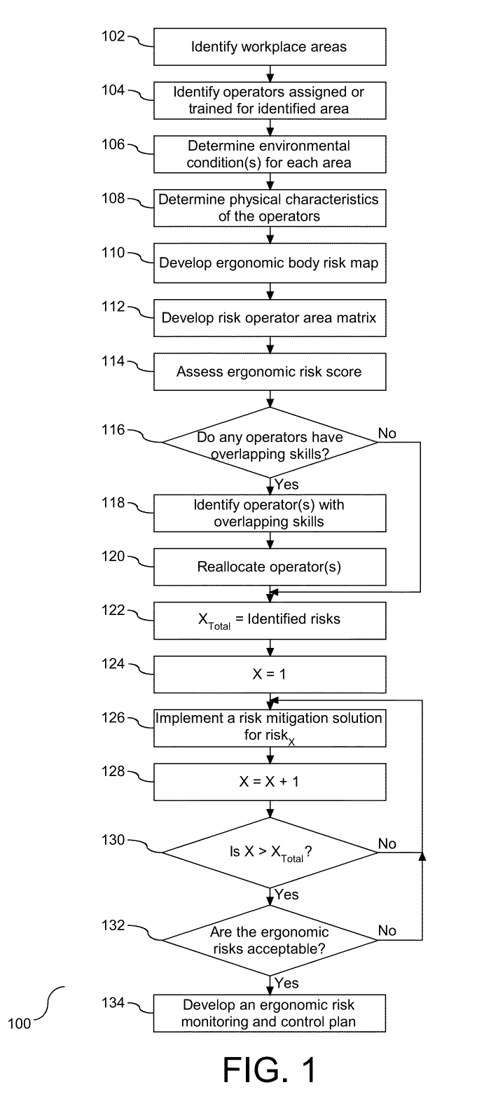

Referring to FIG. 1, a flow chart (100) is provided illustrating a process for ergonomic risk assessment. As shown, areas with the workplace environment are identified (102). In one embodiment, the workplace refers to the physical plant, such as a manufacturing facility. The physical plant may be sub-divided into multiple areas, with each area separated by specific tasks or functions. In addition, and as articulated above, each identified area may have one or more operators that are trained to work in those specific area. Following step (102), for each identified area, operators assigned or trained to work in those areas are identified (104). In addition and prior to any ergonomic evaluation, environmental conditions for each area are determined (106). Examples of such conditions include, but are not limited to, illumination, noise, etc. Human factors are also accounted for in the assessment. Following step (106), the physical characteristics of the operators are determined (108). Such characteristics include, but are not limited to height, weight, heart rate, etc. Accordingly, prior to evaluation of the assessment, the factors that are employed in the assessment are identified.

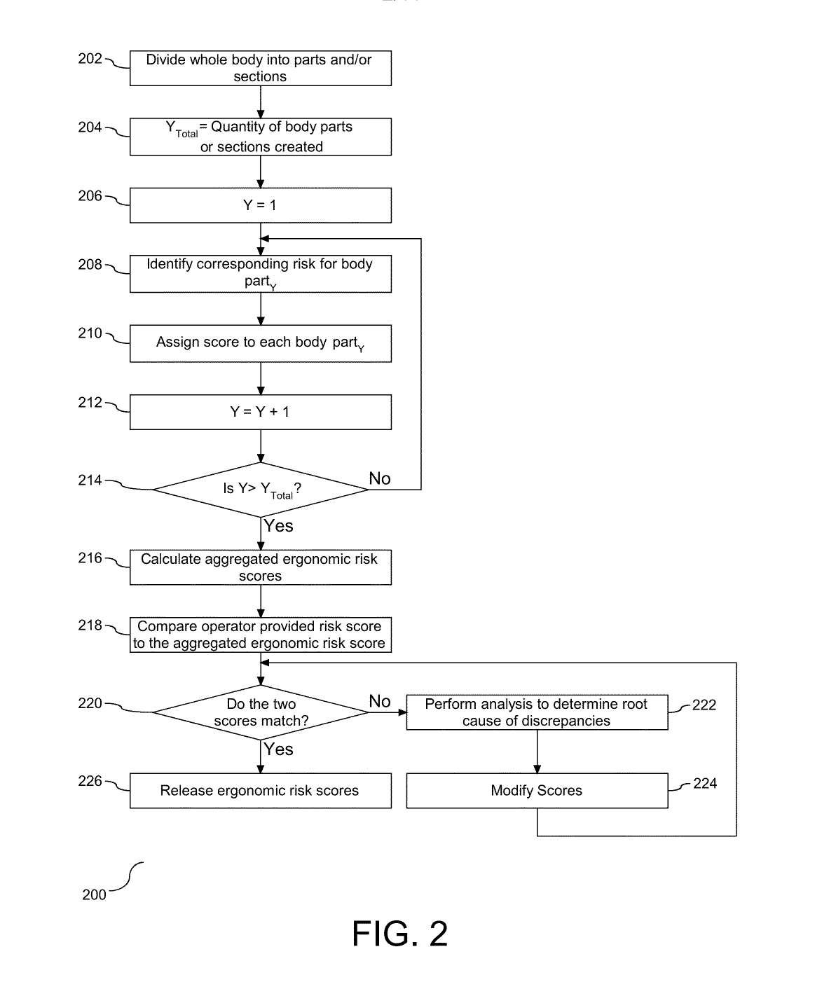

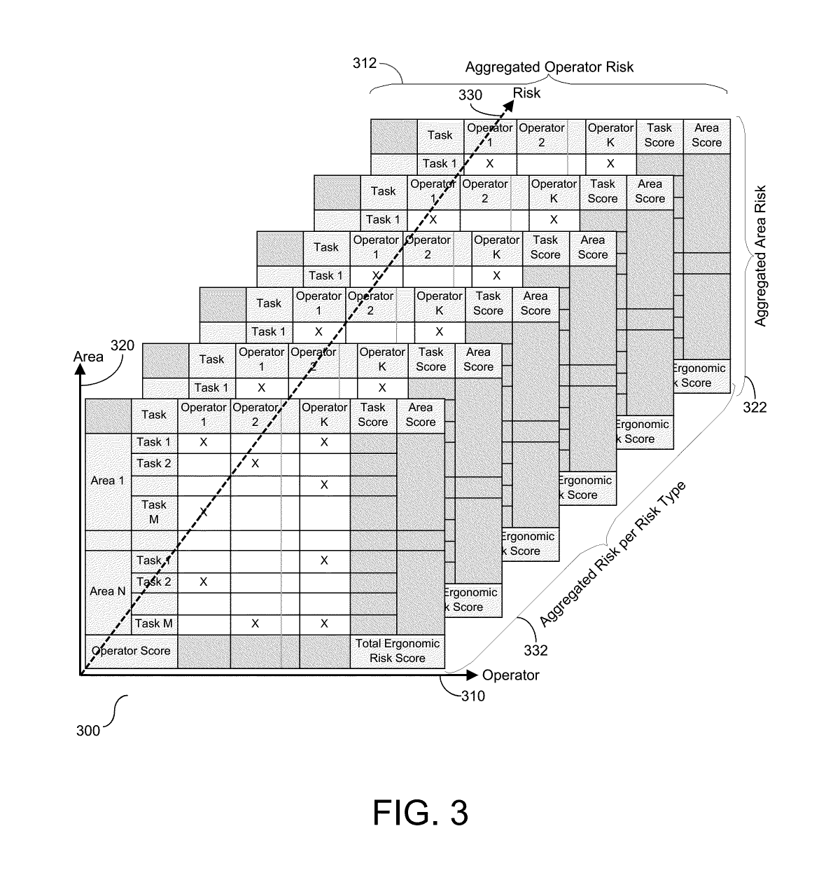

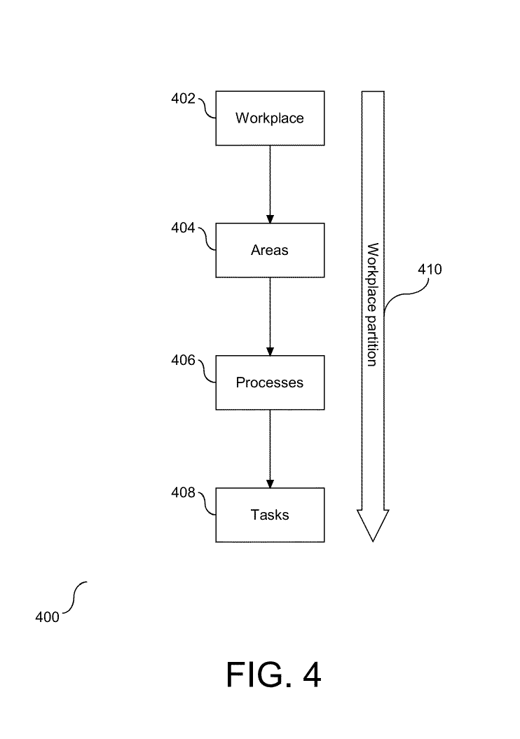

Once the assessment factors have been compiled, an assessment evaluation takes place. As shown, an ergonomic body risk map is developed (110). Details of the map development are shown and described in FIG. 2. In one embodiment, a separate map is developed for each operator and each work area. Following step (110), a risk operator area matrix is developed (112). An example of the matrix is shown and described in FIG. 3. In one embodiment, the matrix is developed for each operator and each work area. The matrix supports and enables evaluation of ergonomic metrics to mitigate ergonomic risk and increase workplace performance. Based on the body risk map and the matrix, an ergonomic risk score is assessed (114). Details of the assessment are shown and described in FIG. 4. The assessment is aggregated per operator, work area, and risk type. Assessed risk may be operator specific, area specific, or a combination of the operator and area. For example, based on operator characteristics, a risk for one operator may not be a risk for a different operator. Accordingly, the risk assessments shown and described herein are both operator specific and work area specific.

Following step (114), it is determined if any of the operators that are the subjects of the risk assessment(s) have overlapping skills (116). The importance of this determination enables the assessment to consider replacement or substitution as a solution to any evaluated risk that is operator specific. If the response to the determination at step (116) results in overlapping skills, then the operator(s) with overlapping skills are identified (118), and at least one operator is reallocated to replace the prior operator identified with an ergonomic risk score that exceeds a defined threshold (120). The reallocation at step (120) results in workload balance and minimizes ergonomic risk. In one embodiment, two or more operators may have been assessed with an excessive risk score, and one or all of the operators may be subject to replacement at step (120).

One solution for risk mitigation may take place through operator replacement, as shown as steps (118) and (120). However, this is only one solution and other steps may be employed to mitigate the assessed risk so that the replacement operator(s) will not be subject to the same or similar risk as the replaced operator(s). In one embodiment, the risk mitigation solution may take place in conjunction with the operator replacement, or independent of any operator replacement. Following the reallocation at step (120) or a negative response to the determination at step (116), risk minimization controls are implemented to mitigate the assessed ergonomic risk(s). More specifically, the variable X_{Total} is assigned to represent the identified risks (122), and an associated risk counting variable is initialized (124). For each identified risk_{X}, a risk mitigation solution is implemented (126). Risk mitigation may take on various forms depending on characteristics of the risk. For example, in one embodiment, the risk mitigation may require one or more breaks to be added to the work schedule. In another embodiment, risk mitigation may be in the form of an engineering control, such as a station re-design, or personal protective equipment (PPE). In another embodiment, the risk mitigation may encompass all of the solutions described herein, or alternative solutions. Accordingly, the risk mitigation solutions shown and described herein should not be considered limiting.

Following the risk mitigation implementation at step (126), the risk counting variable is incremented (128). It is then determined if all of the identified risks have been assessed for mitigation (130). A negative response to the determination at step (130) is followed by a return to step (126), and a positive response concludes the individual risk mitigation process. Following step (130), it is then determined if after implementation of one or more risk mitigation solutions, the ergonomic risks are acceptable (132). In one embodiment, the ergonomic risk map shown and described in FIG. 2 is consulted to determine acceptable levels of ergonomic risk per operator. If the response to the determination at step (132) is negative, this is an indication that further risk mitigation is necessary, and the process returns to step (126). At the same time, a positive response to the determination at step (132) is followed by development of an ergonomic risk monitoring and control plan (134). More specifically, there is always a potential for risk as conditions and operators change and evolve, and as new risks surface. To ensure the ergonomic safety of the environment under evaluation the monitoring and control place may be reassessed on a periodic basis, such as every 3 to 6 months. Ergonomic risks are dynamic, they change and evolved, and as such, the monitoring and control plan ensures that ergonomic risks are periodically identified and resolved.

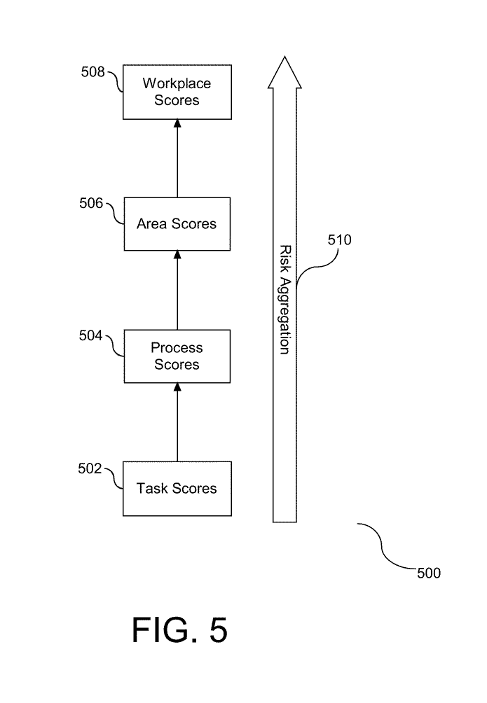

As shown and described in FIG. 1, ergonomic risks may be operator dependent. An ergonomic risk for one operator may not be an ergonomic risk for another operator. Similarly, an ergonomic risk for one operator may be magnified or reduced for another operator. To address operator specific ergonomic risks, a body risk map is built for each operator. Referring to FIG. 2, a flow chart (200) is provided illustrating a process for building a body risk map. As shown, the whole body is divided into parts and/or sections (202). A variable, Y_{Total}, is assigned to the quantity of body parts or sections created (204), and an associated counting variable, Y, is initialized (206). A corresponding risk is identified for body part_{Y} (208) and a score is assigned to each body part_{Y} (210). In one embodiment, there are eight risk types, including but not limited to, energy expenditure, hand-arm vibration, whole-body vibration, noise, illumination, temperature, posture, and low back force. Similarly, different scoring systems may be employed to quantify the ergonomic risk. In one embodiment, the scoring system is numerical. In another embodiment, the scoring system is color coordinated, with a color corresponding to a quantified risk assigned to an assessed body part of region. Details of the scoring system are shown and described in FIGS. 4 and 5. Following step (210), the body part counting variable is incremented (212), and it is determined if all of the identified body parts have been assessed (214). A negative response to the determination at step (214) is followed by a return to step (208), and a positive response concludes the initial part of building the body risk map.

Two or more risks may be identified for each body part or region. Following the individual part or region assessment, an ergonomic risk score is calculated in the form of an aggregated score across all the identified parts and regions (216). In one embodiment, the assessment at step (216) identifies all risk types per body part, and aggregates all body part risks for one final and complete risk score per operator. In addition, each operator that is the subject of the ergonomic risk assessment provides a personal ergonomic risk score in the form of an objective score analysis which may take place prior or subsequent to creation of the body risk map. Following step (216), the operator provided risk score is compared to the aggregated ergonomic risk score (218). In one embodiment, this assessment is operator based, and as such is separate for each operator. There are two different ergonomic risk scores, one of which is a perceptive score provided by the operator, and a second which is based on the body risk map. Following step (218), the two scores are compared to determine if they match (220). More specifically, the comparison at step (220) may be an exact match or a match within a range. If the scores do not match or are not within a range of matching, an analysis is performed to determine the root causes of the discrepancy (222), after which the perceptive or objective scores are modified (224) followed by a return to step (220). However, a positive response to the determination at step (220) is followed by a release of the ergonomic risk scores (226) to an interested party, such as a department of ergonomic assessment, a manager, etc. Accordingly, the body build map is employed to assess regional risk analysis and aggregated risk analysis, and to compare the aggregated analysis for feedback from the individual subject to assessment.

Referring to FIG. 3, a block diagram (300) of a risk operator area matrix is provided. As shown in the matrix, there are three axis, including operator (310), area (320), and risk (330). Ergonomic risks may be assessed individually per work area, per operator, or per risk category. At the same time, the risks may be aggregated to produce an aggregated operator risk (312), an aggregated area risk (322), and an aggregated risk per risk type (332). Although three dimensions are shown in the matrix, the quantity of dimensions should not be considered limiting, and in one embodiment, the quantity may vary. Accordingly, the matrix is a tool for assessing ergonomic risks.

Referring to FIGS. 4 and 5, flow charts are provided illustrating a process for scoring ergonomic risk. As shown, the scoring aspect is divided into workplace partition (410) and risk aggregation (510) More specifically, FIG. 4 is a flow chart (400) illustrating a process for assessing a workplace partition. The entire workplace is subject to partition. As shown, the workplace (402) is partitioned into areas (404) based on their ergonomic requirements and conditions. Areas (404) are partitioned into processes (406), and processes are partitioned into tasks (408). With respect to risk aggregation as shown and described in FIG. 5, ergonomic risks are evaluated in a task basis. As shown, task scores are aggregated (502) to calculate process scores (504) which is aggregated to calculate a risk score per area. Thereafter, area scores are aggregated (506) to calculate the entire workplace risk score (508).

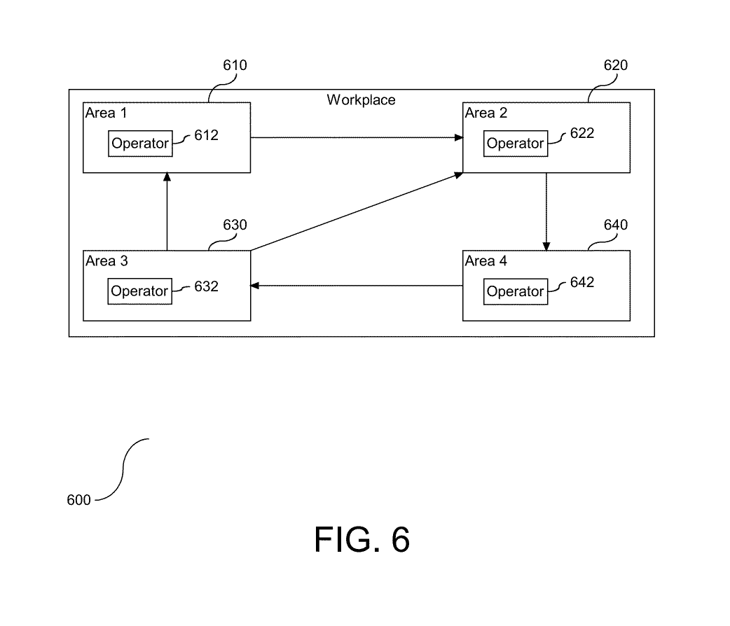

Referring to FIG. 6, a block diagram (600) is provided illustrating a workplace, and specifically workplace areas. As shown, the work place is represented by a collection of areas. For purposes of description, four areas (610), (620), (630), and (640) are shown herein, although the quantity of areas shown should not be considered limiting. In order to assess ergonomic risks in the workplace, the workplace is represented by a collection of areas, and risks are evaluated per each area. Moreover, ergonomic risk exposures are evaluated per risk type, e.g. noise, posture, vibration, etc. Different areas in the workplace may present different ergonomic hazards. Risks are evaluated per task and per process, e.g. group of tasks. Each area is shown with one operator (612), (622), (632), and (642), respectively. However, one or more of the areas may include more than one operator, or an operator may work in different areas. Different areas in the workplace may present different ergonomic hazards. At the same time, each area may have that operator assigned to more than one tasks. Each of these factors, areas, operators, tasks, etc. is taken into consideration for ergonomic risk evaluation. The following formula is employed to numerically assign a value to what is referred to as the partition-aggregation approach:

$$\overline{R} = {( \frac{1}{n} {\sum }_{i = 1}^{n} {( {R}_{i} )}^{n} )}^{\frac{1}{n}}$$

As shown, assessment of ergonomic risks starts with a task, n, and then aggregates multiple task risks R, e.g. tasks' risks, to assign a numerical value to the risk area.

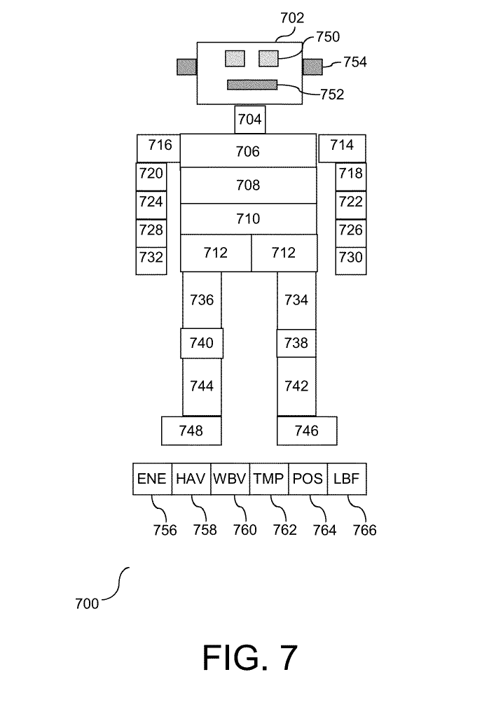

A body risk map is a tool to visualize ergonomic risks on different parts of the human body. FIG. 7 is a block diagram (700) illustrating an example of a body risk map. As shown, the body is divided into twenty four parts (702)-(748), in addition to the eyes (750), mouth (752), and ears (754). In addition to the body parts, other ergonomic measures are included in the lower part of the body map, these measures include: energy expenditure (756), hand-arm vibration (758), whole-body vibration (760), energy expenditure (760), temperature (762), posture (764), and low back compression force (766). Noise is illustrated by the ears (754). Illumination is illustrated by the eyes (750). Posture and force risk is represented by other body parts. The mouth (752) is shown with a specific shape and/or color that are subject to change. The mouth shape and color is an indicator of feedback from the worker regarding the workplace ergonomic conditions, and is also used to validate the measurements. The body map may have an associated color code or an equivalent representation schedule to demonstrated risk for each of the identified parts. With respect to coding the chart, a first indicia is employed to represent a low or no ergonomic risk, a second indicia is employed to represent a medium ergonomic risk, a third indicia is employed to represent a high risk, and a fourth indicia is employed to represent a very high risk. Accordingly, each region of the map may be represented on a scale of 1:5 ranging from a low or no ergonomic risk to a very high risk.

The body risk map is generated after gathering ergonomic requirements and compiling the requirements with feedback and opinion. Ergonomic requirements are the guidelines and recommendations for designing, constructing, and modifying workstations and work environments to avoid ergonomic risks. More specifically, ergonomic requirements are all about preventing strains and other injuries to workers, so as to provide them with a safe environment to work. Accordingly, input and feedback from the worker(s) is a component in the development of ergonomic requirements.

Controls are implemented to eliminate or reduce ergonomic risks, including: administrative controls, engineering controls, and personal protective equipment. To mitigate ergonomic risks, the possible controls that can be used are identified. The following table illustrates risk category and associated controls:

TABLE 1

| | | | Personal |
|---|---|---|---|
| Ergonomic Risk | Administrative | Engineering | Protective |
| Category | Controls | Controls | Equipment |
| Energy | Operator Training, | Job redesign | Light |
| Expenditure | Rest, Breaks | | clothing |
| Noise | Operator training | Noise Shields | Ear plugs |
| Hand-Arm | Operator training | Tool Change/ | Gloves |
| Vibration | | redesign | |
| Whole Body | Operator training | Tool Change/ | Vibration |
| Vibration | | redesign | absorbing |
| | | | material |
| Illumination | Operator training | Light Change/ | Safety glasses |
| | | Adjustment | |
| Temperature | Operator training | Proper Air | Protective |
| | | Conditioning | clothing |
| Posture/Force | Operator training | Job redesign | Lifting Aids |

The impact of each risk is evaluated in terms of cost, time, and reputation. Ergonomic risks can lead to time off work, loss of productivity, compensation claims, and in one embodiment may affect the company's reputation. In one embodiment, ergonomic risks factors can be correlated and the risk will increase if the worker is exposed to additional factors. For example, if the worker is exposed to a whole-body vibration risk, the risk can be magnified if the posture of the worker is poor. Accordingly, response strategies are implemented to address single and compounded risks.

Risk is defined in terms of risk score, also referred to herein as a risk likelihood, and risk impact. The following table is used to prioritize risks by considering both the risk score and risk impact.

TABLE 2

Score

| Impact | Low | Medium | High | Very High |
|---|---|---|---|---|
| Low | Low | Low | Low | Medium |
| Medium | Low | Medium | Medium | High |
| High | Low | Medium | High | Very High |
| Very High | Medium | High | Very High | Very High |

Based on the risk score and impact, a response strategy may be implemented. Response strategies are risk mitigation responses. In one embodiment, risk response strategies can be classified into five categories. Examples of such strategies include, but are not limited to risk avoidance, risk reduction, risk transfer, risk acceptance, and ignoring risk. Each of these risk factors can be identified by observations and measurements.

Risk avoidance may be implemented by completely avoiding the risk, including eliminating the root causes and/or consequences. Risk avoidance should precede risk reduction. More specifically, risk avoidance may be suitable when the risk has a high probability and high impact. At the same time the risk avoidance cannot stop the business, although it may involve changing a method of operation, plan, or redesigning the supply chain. Risk reduction involves reducing some of the risks, while accepting other aspects of the risk. More specifically, risk reduction reduces the risk, but does not eliminate all aspects of the identified risk, e.g. there are residual risks. Risk reduction is suitable when the risk has a high probability and low impact. Risk transfer involves transferring the risk to another party. This is suitable when the identified risk has a low probability but a high impact. Risk acceptance is a matter of addressing and acknowledging the identified risk. More specifically, risk acceptance is suitable when the risk has a low probability and a low impact. In one embodiment, the risk acceptance is employed when the cost of avoiding, reducing, or transferring the risk is high that it's expected or projected impact. Similarly, in one embodiment, contingency plans can be developed to address risks identified as acceptable. Finally, the aspect of ignoring the risk addresses risks that are neither identified nor studied. Ignoring the risk should not be confused with risk acceptance, which identifies and analyzes the risk. In one embodiment, ignoring the risks can in itself represent a risk. Accordingly, for each identified risk and associated risk category, one or more strategies may be implemented to mitigate the risk affect(s).

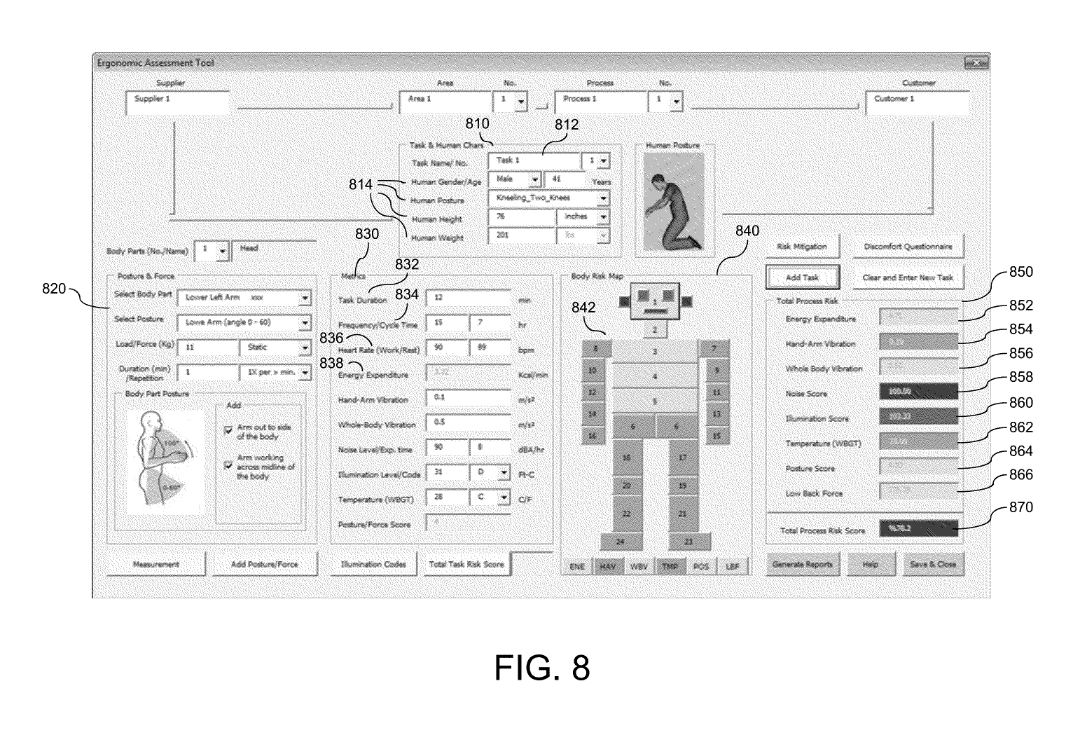

A risk assessment tool is employed to facilitate identification and mitigation. Referring to FIG. 8, a block diagram (800) is provided illustrating an interface for the tool. The interface includes a plurality of fields. A first field (810) identifies the identified task (812) together with operator characteristics (814). A second field (820) identified the posture and force of the operator. A third field (830) identifies task metrics, including task duration (832), frequency (834), heart rate (836), energy expenditure (838), etc. In one embodiment, additional metrics may be identified, and as such, the metrics identified herein are not to be considered limiting. A fourth field (840) illustrates the body risk map (842), as shown and described in detail in FIG. 6. A fifth field (850) illustrates the total process risk, including energy expenditure (852), hand-arm vibration (854), whole body vibration (856), noise score (858), illumination score (860), temperature (862), posture score (864), and low back force (866). In one embodiment, the quantified risks shown herein can include additional or fewer risks, and as such, the quantity should not be considered limiting. In addition, each quantified risk (852)-(866) is shown with a numerical value quantifying the identified risks. In addition to each of the designated risks and associated quantifications, a total process risk score is calculated and presented (870). Furthermore, in one embodiment, a threshold or a plurality of threshold values may be implemented for each of the quantified risks (852)-(866) and the total process risk score (870). Any score that meets or exceeds the associated threshold value is assigned a color, with a legend (not shown) indicating the level of risk associated with the color, e.g. low, medium, high, and very high. Accordingly, the tool provides a plurality of indicia to identify, present, and quantify risks for a process.

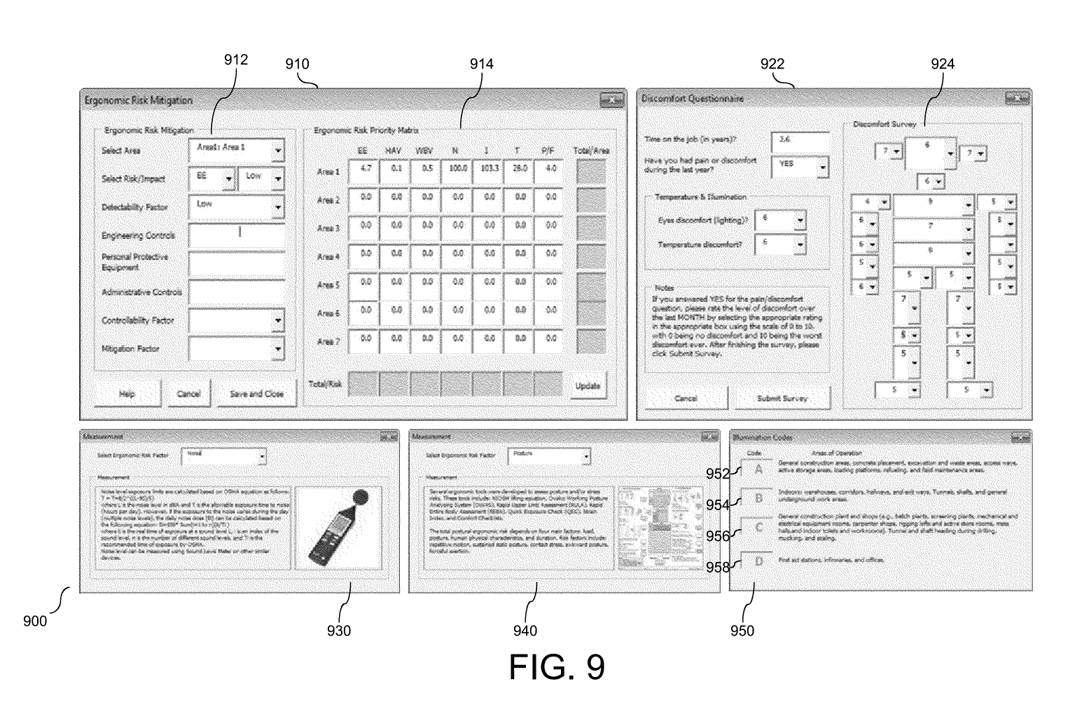

For each identified risk, there may be aspects of the risk that may be eligible for reduction, so as to minimize or otherwise eliminate identified risk. Referring to FIG. 9, a block diagram (900) is provided illustrating an interface for implementing risk mitigation. There are five primary fields (910), (920), (930), (940), and (950), although the quantity of identified fields should not be considered limiting. As shown, one of the fields (910) addresses risk mitigation, and includes a plurality of secondary fields therein, including secondary fields (912) for risk mitigation and an ergonomic risk priority matrix (914). The risk mitigation fields (912) identify the risk area, and enable selection and input of risk and impact, as well as a detectability factor. The matrix (914) addresses a plurality of identified work areas, and for each area addresses ergonomic risks. In one embodiment, the values received and presented in the matrix (914) area received from the fields (912). Similarly, the matrix shows separate compilation of the risks within the matrix, access a singular area, or across each of the risks on a per area basis.

Another field (920) pertains to worker discomfort. A questionnaire (922) is presented on a per worker basis and enables select ergonomic quantification. Based on the data receiving from the questionnaire (922) a body risk map (924) is shown demonstrating risks per area as received from the questionnaire. More specifically, the questionnaire (922) serves as a platform to incorporate human feedback into an ergonomic body risk map (ERBM) to compare the calculated risk score with human comfort level. In one embodiment, the ERBM functions as an ergonomic risk body map showing body areas with associated risk levels. Each delineated area of the map (924) is separately addressable, with each area having an identified or quantified risk. More specifically, the EBRM assesses ergonomic risk of the person considering human physical characteristic, including but not limited to gender, weight, etc., task requirements, including but not limited to physical force required to perform tasks, and environmental conditions, including but not limited to illumination, noise, and vibration.

As shown and described above, risks are identified based on input received from an operator, and sometimes from devices. Field (930) receives input for ergonomic risk(s) as detected and received from one or tools. For example, noise may be measured by a sound meter, temperature may be measured by a thermometer, etc. In one embodiment, a pull down menu is provided and measured data is entered into the associated field. Similarly, several ergonomic tools are employed to assess posture and/or ergonomic stress. These tools include, but are not limited to, NIOSH lifting equation, Ovako Working Posture Analysis System (OWAS), Rapid Upper Limb Assessment (RULA), Rapid Entire Body Assessment (REBA), Quick Exposure Check (QEC), Strain Index, and Comfort Checklists. The total postural ergonomic risk depends on four main factors: load, posture, human physical characteristics, and duration. Risk factors include: repetitive motion, sustained static posture, contact stress, awkward posture, and forceful exertion. Field (940) quantifies one or more of these measurements. In one embodiment, a pull down menu is provided to identify a specific measurement.

Field (950) is provided to demonstrate illumination codes. More specifically, different structural areas are provided different illumination codes. There are four fields shown herein, although the quantity of fields should not be considered limiting. The first field (952) designates general construction areas, concrete placement, excavation and waste areas, access ways, active storage areas, loading platforms, refueling, and field maintenance areas. Each of the areas listed in field (952) are designated with a first designation code or indicia. The second field, (954), designates indoor areas, warehouses, corridors, hallways, and exit ways, as well as tunnels, shafts, and general underground work areas. Each of the areas listed in field (954) are designated with a second designation color or indicia. The third field, (956), designates general construction plant and shops. These areas are designated with a third designation color or indicia. The fourth field, (958), designates first aid stations, infirmaries, and offices. Each of the areas listed in field (958) are designated with a fourth color or indicia.

The ergonomic risk assessment described and shown herein may be applied to service or manufacturing environments. The assessment is comprehensive in that is takes into consideration different ergonomic risks in the workplace, including posture and force, workload, noise, illumination, vibration, and temperature. In one embodiment, the assessment is referred to as a partition aggregation in which the workplace is divided into multiple areas, with the area separated into processes, and the processes divided into tasks. The ergonomic risk is assessed at the task level and then aggregated per process and then per area. Ergonomic risk calculations by area and operator are used to allocate or reallocate the appropriate operator to a tasks or resource so that the aggregated risk cannot be higher than the allowable ergonomic risk limit. Risks scores are calculated and considered for operators working in multiple and different areas. Accordingly, ergonomic risks are assessed for operator allocation and workload balancing.

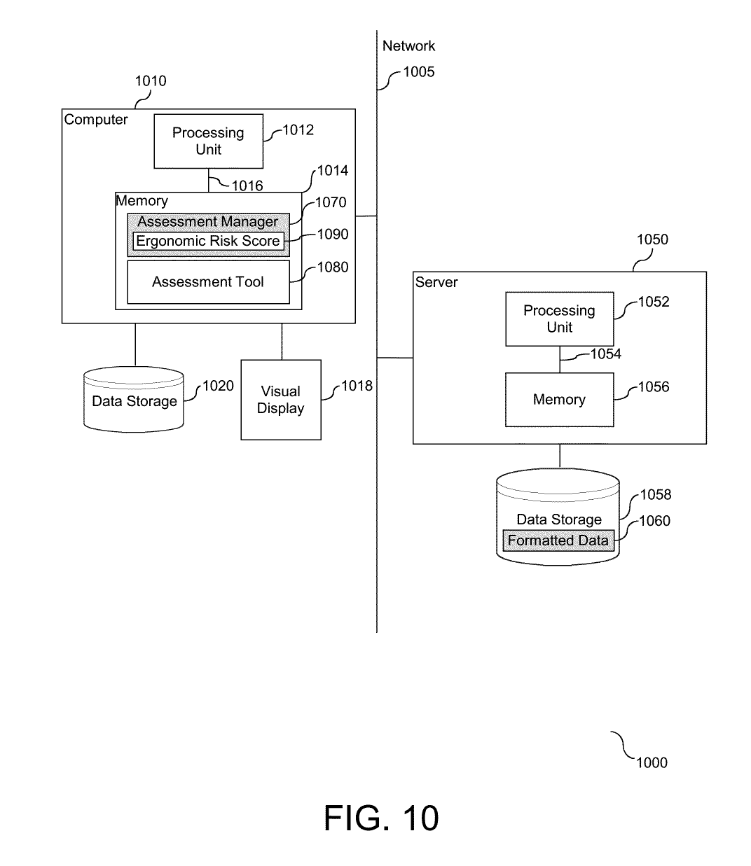

As shown in FIGS. 1-9, ergonomic risks are assessed and operators are allocated or reallocated. Referring to FIG. 10, a block diagram (1000) is provided depicting a system for ergonomic risk assessment. The system (1000) is shown with a computer (1010) provided with a processing unit (1012) in communication with memory (1014) across a bus (1016), a visual display (1018), and data storage (1020). The computer (1010) is in communication with one or more additional machines (1050), referred to herein as a server, across a network connection (1005). In one embodiment, the server (1050) is provided with a processing unit (1052) in communication with memory (1056) across a bus (1054), and data storage (1058).

Data, such as ergonomic risk characteristics and assessments, operator, etc. may be captured and stored in local data storage (1020) or remote data storage (1058). To support ergonomic risk assessment, an assessment manager (1070) is provided in communication with an assessment tool (1080), hereinafter referred to collectively as tools. More specifically, the tools (1070) and (1080) support the ergonomic risk assessment, and in one embodiment, risk reallocation, as shown and described in FIGS. 1-9.

The assessment manager (1070) functions to plan operational tasks of a workplace. These functions include receipt and storage of workplace assessment data. The workplace is separated into two or more areas, and one or more operators are selectively assigned to the areas based on a plurality of factors, including competency and ergonomic risk. For each workplace area, the assessment manager (1070) evaluates the ergonomic risk(s). The evaluation is based on physical characteristics of the area(s), operator(s), and/or identified tasks to be completed per area and per operator. In one embodiment, the assessment manager (1070) generates an initial ergonomic risk score (1090), which may be stored in memory (1014) or data storage (1058). The assessment manager (1070) works in conjunction with an assessment tool (1080). In one embodiment, the assessment tool (1080) is stored in memory (1014), or is accessible across the network (1005) from server (1050). The assessment tool (1080) is employed to balance workload based on the calculated cumulative score. More specifically, the tool (1080) assesses the risk per identified physical area, a risk type factor, and per operator, and in addition assesses and/or identifies at least one workload resource that is available for modification and that may meet a balance goal. The assessment tool (1080) creates the formatted modification data (1060) and application of this formatted data (1060) to an associated workload schedule, thereby minimizing ergonomic risk through allocation of resources. In one embodiment, the creation of formatted modification data relies on ergonomic data formatting software. The application of workload balance minimizes ergonomic risk. In one embodiment, the manager (1070) allocates or reallocates resources to enable and support the minimization of the risk.

The assessment tool (1080) functions to receive, organize, and cumulate risk data. For example, the tool (1080) generates an aggregated risk per risk type. In one embodiment, the tool (1080) employs a graphical user interface (GUI), and operator input and feedback is received by the tool (1080) and incorporated into the assessment and evaluation. For example, the tool (1080) may receive operator feedback data, which may then be employed by the tool (1080) as a factor associated and/or otherwise combined with the formatted data (1060), and compares the calculated risk score with a comfort level. In one embodiment, the tool (1080) employs an ergonomic body risk map. The feedback data is incorporated into the risk map so that the calculated risk score may be compared with the comfort level. The ergonomic risks as identified by the tool and described in detail in FIG. 8, considers a plurality of data when creating the formatted modification data, including physical characteristics, task requirements, and environmental conditions. More specifically, the feedback data provides real-time data from the operator to the tool (1080), which is employed by the manager (1070) for ergonomic assessment.

The functionality of the assessment manager (1070) and assessment tool (1080) may be considered as addressing downstream data and upstream data. More specifically, the downstream data pertains to the above-described workplace data, environmental conditions, operator characteristics, etc. This data is monitored and gathered to improve upstream performance, also referred to herein as the workload schedule. The assessment tool (1080) functions to evaluate electronically formatted data regarding downstream data points, and uses the evaluation to statistically assess upstream performance. Accordingly, the assessment manager (1070) and assessment tool (1080) function to evaluate downstream data points, in the form of ergonomic metrics, create formatted ergonomic data, and to improve upstream performance, in the form of workplace schedule that accommodates and/or accounts for ergonomic risk mitigation.

The server described above in FIG. 10 has been labeled with tools (1070) and (1080), to facilitate and ergonomic risk evaluation. The tools may be implemented in programmable hardware devices such as field programmable gate arrays, programmable array logic, programmable logic devices, or the like. The tools may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the tools need not be physically located together, but may comprise disparate instructions stored in different locations which, when joined logically together, comprise the tools and achieve the stated purpose of the tool.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

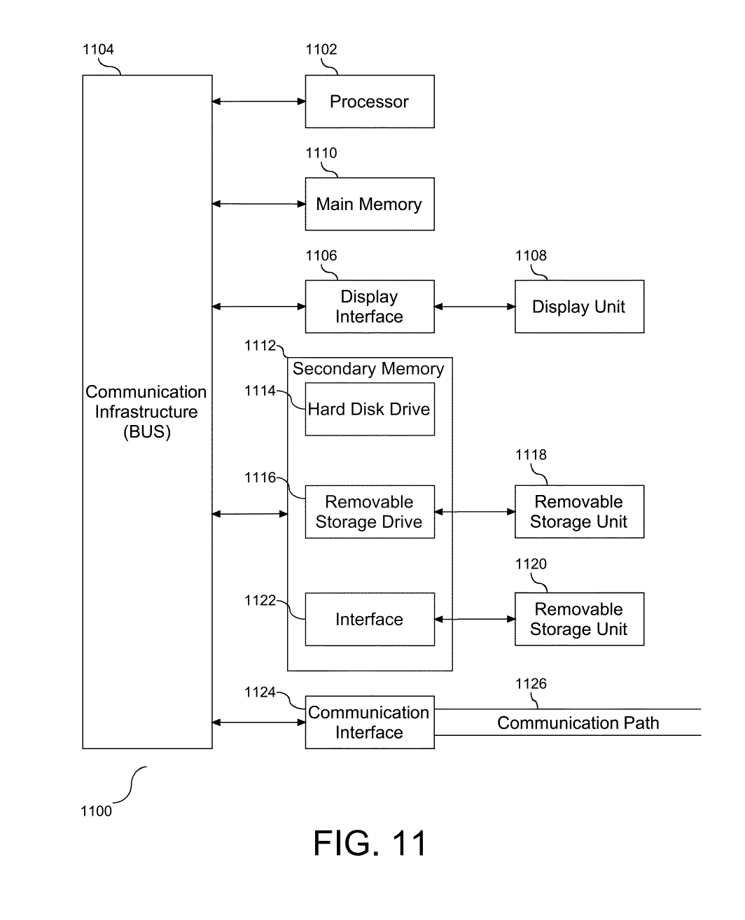

Referring now to the block diagram of FIG. 11, additional details are now described with respect to implementing an embodiment of the present invention. The computer system includes one or more processors, such as a processor (1102). The processor (1102) is connected to a communication infrastructure (1104) (e.g., a communications bus, cross-over bar, or network).

The computer system can include a display interface (1106) that forwards graphics, text, and other data from the communication infrastructure (1104) (or from a frame buffer not shown) for display on a display unit (1108). The computer system also includes a main memory (1110), preferably random access memory (RAM), and may also include a secondary memory (1112). The secondary memory (1112) may include, for example, a hard disk drive (1114) and/or a removable storage drive (1116), representing, for example, a floppy disk drive, a magnetic tape drive, or an optical disk drive. The removable storage drive (1116) reads from and/or writes to a removable storage unit (1118) in a manner well known to those having ordinary skill in the art. Removable storage unit (1118) represents, for example, a floppy disk, a compact disc, a magnetic tape, or an optical disk, etc., which is read by and written to by removable storage drive (1116).

In alternative embodiments, the secondary memory (1112) may include other similar means for allowing computer programs or other instructions to be loaded into the computer system. Such means may include, for example, a removable storage unit (1120) and an interface (1122). Examples of such means may include a program package and package interface (such as that found in video game devices), a removable memory chip (such as an EPROM, or PROM) and associated socket, and other removable storage units (1120) and interfaces (1122) which allow software and data to be transferred from the removable storage unit (1120) to the computer system.

The computer system may also include a communications interface (1124). Communications interface (1124) allows software and data to be transferred between the computer system and external devices. Examples of communications interface (1124) may include a modem, a network interface (such as an Ethernet card), a communications port, or a PCMCIA slot and card, etc. Software and data transferred via communications interface (1124) is in the form of signals which may be, for example, electronic, electromagnetic, optical, or other signals capable of being received by communications interface (1124). These signals are provided to communications interface (1124) via a communications path (i.e., channel) (1126). This communications path (1126) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (1110) and secondary memory (1112), removable storage drive (1116), and a hard disk installed in hard disk drive (1114).

Computer programs (also called computer control logic) are stored in main memory (1110) and/or secondary memory (1112). Computer programs may also be received via a communication interface (1124). Such computer programs, when run, enable the computer system to perform the features of the present invention as discussed herein. In particular, the computer programs, when run, enable the processor (1102) to perform the features of the computer system. Accordingly, such computer programs represent controllers of the computer system.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the functions /acts specified in the flowcharts and/or block diagrams block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowcharts and/or block diagrams block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. The implementation of ergonomic assessment combines ergonomics with workload assignment, with the improvement lending itself to increased workload efficiency. Specifically, ergonomic risk is minimized based on consideration of one or more mitigation strategies, their effectiveness, and ease of implementation. Accordingly, the assessment enables workplace modification(s) which minimizing ergonomic risk through allocation of resource.

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

What is claimed is:

1. A method comprising:
planning operational tasks of a workplace, including receiving and storing workplace assessment data;
for each work area, evaluating ergonomic risk based on physical characteristics and the planned tasks, including generating an initial ergonomic risk score;
for each operator, assessing an operator risk including a risk area factor and a risk type factor;
calculating a cumulative ergonomic risk score, wherein the cumulative score calculation is aggregated across each operator, workplace area, and task; and
though a host computer, balancing workload based on the calculated cumulative score, including identifying one or more workload resources available for modification to meet a balance goal, the balancing including creation of formatted modification data and applying the formatted data to a workload schedule for minimizing ergonomic risk through allocation of resources.

2. The method of claim 1, further comprising developing a risk operator matrix for assessing the operator risk.

3. The method of claim 2, further comprising the matrix generating an aggregated risk per risk type.

4. The method of claim 1, further comprising receiving operator feedback and comparing the feedback to the initial ergonomic risk score.

5. The method of claim 4, wherein the workload modification to meet the balance goal includes operator reallocation to attain workload balance and minimize ergonomic risk.

6. The method of claim 4, further comprising incorporating feedback into an ergonomic body risk map and comparing the calculated risk score with an ergonomic comfort level.

7. The method of claim 6, wherein the map assesses ergonomic risks considering physical characteristics, task requirements, and environmental conditions.

8. A computer program product for assessing an ergonomic risk, the computer program product comprising a computer readable storage device having program code embodied therewith, the program code executable by a processing unit to:
plan an operational task of a workplace, including receipt and storage of workplace assessment data;
evaluate an ergonomic risk based for each work area, the risk based on physical characteristics and the planned tasks, including generation of an initial ergonomic risk score;
assess an operator risk including a risk area factor and a risk type factor;
calculate a cumulative ergonomic risk score; and
balance workload based on the cumulative score, including identification of one or more workload resources available for modification to meet a balance goal, including creation of formatted modification data and application of the formatted data to a workload schedule to minimize ergonomic risk through allocation of one or more resources.

9. The computer program product of claim 8, wherein the cumulative score calculation is aggregated across each operator, workplace area, and task.

10. The computer program product of claim 8, further comprising program code to assess the operator risk.

11. The computer program product of claim 8, further comprising program code to generate an aggregated risk per risk type.

12. The computer program product of claim 8, further comprising program code to receive operator feedback data and to compare the feedback to the initial ergonomic risk score.

13. The computer program product of claim 12, further comprising program code to incorporate the feedback into an ergonomic body risk map, and compare the calculated risk score with a comfort level.

14. The computer program product of claim 13, wherein the map assesses ergonomic risks considering physical characteristics, task requirements, and environmental conditions.

15. A system comprising:
a processing unit in communication with memory;
an assessment manager in communication with the processing unit, the assessment manager to plan operational tasks of a workplace, including receipt and storage of workplace assessment data;
for each workplace area, the assessment manager to evaluate ergonomic risk based on physical characteristics and the planned tasks, including generation of an initial ergonomic risk score;
an assessment tool to assess an operator risk, including a risk area factor and a risk type factor, on an operator basis;
the assessment tool to calculate a cumulative ergonomic risk score, wherein the cumulative score calculation is aggregated across each operator, workplace area, and task; and
the assessment tool, through a host computer, to balance workload based on the calculated cumulative score, including identified of one or more workload resources available for modification to meet a balance goal, including creation of formatted modification data and application of the formatted data to a workload schedule for minimization of ergonomic risk through allocation of resource.

16. The system of claim 15, further comprising the assessment tool to generate an aggregated risk per risk type.

17. The system of claim 15, further comprising the assessment tool to receive operator feedback data and to compare the feedback to the initial ergonomic risk score.

18. The system of claim 17, further comprising the assessment tool to incorporate the feedback into an ergonomic body risk map, and compare the calculated risk score with a comfort level.

19. The system of claim 18, wherein the map assesses ergonomic risks considering physical characteristics, task requirements, and environmental conditions.
